(19) United States
(12) Patent Application Publication
(10) Pub. No.: US 2017/0185365 A1
(43) Pub. Date: Jun. 29, 2017

(54) SYSTEM AND METHOD FOR SCREEN SHARING

(71) Applicant: OPTiM Corporation, Saga (JP)

(72) Inventor: Shunji SUGAYA, Tokyo (JP)

(21) Appl. No.: 15/066,002

(22) Filed: Mar. 10, 2016

(30) Foreign Application Priority Data
Dec. 28, 2015 (JP) 2015-257453

(51) Int. Cl. G06F 3/14; G09B 19/00; G09B 5/14

(52) U.S. Cl. CPC G06F 3/1454; G09B 5/14; G09B 19/0076; G06F 2203/04803; G06F 3/0482

(57) ABSTRACT

The present invention is to provide a system for sharing a screen between an instructor terminal and a user terminal to provide specific guidance in real time. In the system for screen sharing including an instructor terminal 200 and a user terminal 100, the instructor terminal 200 specifies a predetermined area in a shared area in which a screen is shared, provides guidance to the predetermined area, and transmits the guidance to the user terminal 100 and shares the guidance.

### CROSS REFERENCE TO RELATED APPLICATIONS

This application claims priority to Japanese Patent Application No. 2015-257453 filed on Dec. 28, 2015, the entire contents of which are incorporated by reference herein.

### TECHNICAL FIELD

The present invention relates to a system and a method for screen sharing to share a screen between an instructor terminal and a user terminal to provide guidance.

### BACKGROUND ART

Various technologies that support the users' makeup are proposed conventionally. For example, Patent Document 1 describes the technology to support users' makeup based on three-dimensional information acquired by using three-dimensional instrumentation.

### CITATION LIST

### Patent Literature

Patent Document 1: JP 2015-197710A

### SUMMARY OF INVENTION

However, the method of Patent Document 1 enables users to only check their makeup from an image by themselves and to hardly know how to put on their makeup much better. However, users may desire to receive guidance on detailed procedures and how to handle cosmetics on hand from a specialist in real time when they want to put on makeup in a different way from usual or to learn new makeup.

In view of the above-mentioned problems, an objective of the present invention is to provide a system and a method for screen sharing to share a screen between an instructor terminal and a user terminal to provide guidance.

The first aspect of the present invention provides a system for screen sharing including an instructor terminal and a user terminal, in which the instructor terminal includes:

an area specifying unit that specifies a predetermined area in a shared area in which a screen is shared;

a guidance unit that provides guidance to the predetermined area; and

a guidance sharing unit that transmits the guidance to the user terminal to share the guidance.

According to the first aspect of the present invention, a system for screen sharing includes an instructor terminal and a user terminal, in which the instructor terminal includes:

an area specifying unit that specifies a predetermined area in a shared area in which a screen is shared;

a guidance unit that provides guidance to the predetermined area; and

a guidance sharing unit that transmits the guidance to the user terminal to share the guidance.

The first aspect of the present invention is the category of a system for screen sharing, but the category of a method for screen sharing has similar functions and effects.

The second aspect of the present invention provides the system according to the first aspect of the present invention, in which the guidance is on how to put on makeup.

According to the second aspect of the present invention, in the system according to the first aspect of the present invention, the guidance is on how to put on makeup.

The third aspect of the present invention provides a system for screen sharing including one or more instructor terminals, one or more user terminals, and a server, the server being provided with a guidance content database and communicatively connected with the instructor terminals and the user terminals, in which the server includes:

a guidance content acquisition unit that acquires the content of guidance that the instructor terminal provides to the user terminal; and

a guidance content storing unit that stores the acquired content in the guidance content database.

According to the third aspect of the present invention, a system for screen sharing including one or more instructor terminals, one or more user terminals, and a server, the server being provided with a guidance content database and communicatively connected with the instructor terminals and the user terminals, in which the server includes:

a guidance content acquisition unit that acquires the content of guidance that the instructor terminal provides to the user terminal; and

a guidance content storing unit that stores the acquired content in the guidance content database.

The fourth aspect of the present invention provides the system according to the third aspect of the present invention, in which the user terminal includes an evaluation unit that evaluates the content of the guidance.

According to the fourth aspect of the present invention, in the system according to the third aspect of the present invention, the user terminal includes an evaluation unit that evaluates the content of the guidance.

The fifth aspect of the present invention provides a system for screen sharing including one or more instructor terminals, one or more user terminals, and a server, the server being provided with a guidance content database and communicatively connected with the instructor terminals and the user terminals, in which the user terminal includes:

a screen sharing unit that selects a desired instructor terminal and shares a screen with the selected desired instructor terminal; and

an evaluation unit that evaluates the content of the guidance, the instructor terminal includes:

an area specifying unit that specifies a predetermined area in a shared area in which a screen is shared;

a guidance unit that provides guidance on makeup to the predetermined area; and

a guidance sharing unit that transmits the guidance on makeup to the user terminal to share the guidance, and

the server includes:

a guidance content acquisition unit that acquires the content of guidance that the instructor terminal provides to the user terminal; and

a guidance content storing unit that stores the acquired content in the guidance content database.

According to the fifth aspect of the present invention, a system for screen sharing including one or more instructor terminals, one or more user terminals, and a server, the server being provided with a guidance content database and communicatively connected with the instructor terminals and the user terminals, in which the user terminal includes:

a screen sharing unit that selects a desired instructor terminal and shares a screen with the selected desired instructor terminal; and

an evaluation unit that evaluates the content of the guidance,

the instructor terminal includes:

an area specifying unit that specifies a predetermined area in a shared area in which a screen is shared;

a guidance unit that provides guidance on makeup to the predetermined area; and

a guidance sharing unit that transmits the guidance on makeup to the user terminal to share the guidance, and

the server includes:

a guidance content acquisition unit that acquires the content of guidance that the instructor terminal provides to the user terminal;

a guidance content storing unit that stores the acquired content in the guidance content database; and

an evaluation unit that evaluates the content of the guidance.

The sixth aspect of the present invention provides the system according to the fifth aspect of the present invention, in which the evaluation for the content of the guidance is referable when the user terminal selects a desired instructor terminal.

According to the sixth aspect of the present invention, in the system according to the fifth aspect of the present invention, the evaluation for the content of the guidance is referable when the user terminal selects a desired instructor terminal.

The seventh aspect of the present invention provides a method for screen sharing between an instructor terminal and a user terminal including the steps of:

specifying a predetermined area in a shared area in which a screen is shared by the instructor terminal;

providing guidance to the predetermined area by the instructor terminal; and

transmitting the guidance from the instructor terminal to the user terminal to share the guidance between the instructor terminal and the user terminal.

The present invention can provide a system and a method for sharing a screen between an instructor terminal and a user terminal to provide guidance.

### BRIEF DESCRIPTION OF DRAWINGS

FIG. 1 shows a schematic diagram of a preferable embodiment of the present invention.

FIG. 2 shows a functional block diagram of the user terminal 100 and the instructor terminal 200 to show the relationship among the functions.

FIG. 3 shows a flow chart of the guidance process performed by the user terminal 100 and the instructor terminal 200 through screen sharing.

FIG. 4 shows a functional block diagram of the user terminal 100, the instructor terminal 200, and the server 300 to illustrate the relationship among the functions.

FIG. 5 shows a flow chart of the guidance content storing process and the evaluation process performed by the user terminal 100, the instructor terminal 200, and the server 300 after the guidance process.

FIG. 6 shows a flow chart of the instructor selection process and the screen sharing process performed by the user terminal 100, the instructor terminal 200, and the server 300.

FIG. 7 shows one example of the screen of the user terminal 100 when the user selects an instructor.

FIG. 8 shows one example of the screen of the instructor terminal 200 when the instructor generates a makeup sample.

FIG. 9 shows one example of the screen of the user terminal 100 when the user selects a makeup sample.

FIG. 10 shows one example of the screen of the instructor terminal 200 when the instructor specifies an area.

FIG. 11 shows one example of the screen of the instructor terminal 200 when the instructor guides makeup to be put on the specified area.

FIG. 12 shows one example of the screen of the user terminal 100 when the instructor terminal 200 transmits guidance data to the user terminal 100 and shares the guidance content.

FIG. 13 shows one example of guidance data stored in the guidance content database.

FIG. 14 shows one example of data on the evaluation of the guidance content.

### DESCRIPTION OF EMBODIMENTS

Embodiments of the present invention will be described below with reference to the attached drawings. However, this is illustrative only, and the technological scope of the present invention is not limited thereto.

### Overview of System for Screen Sharing

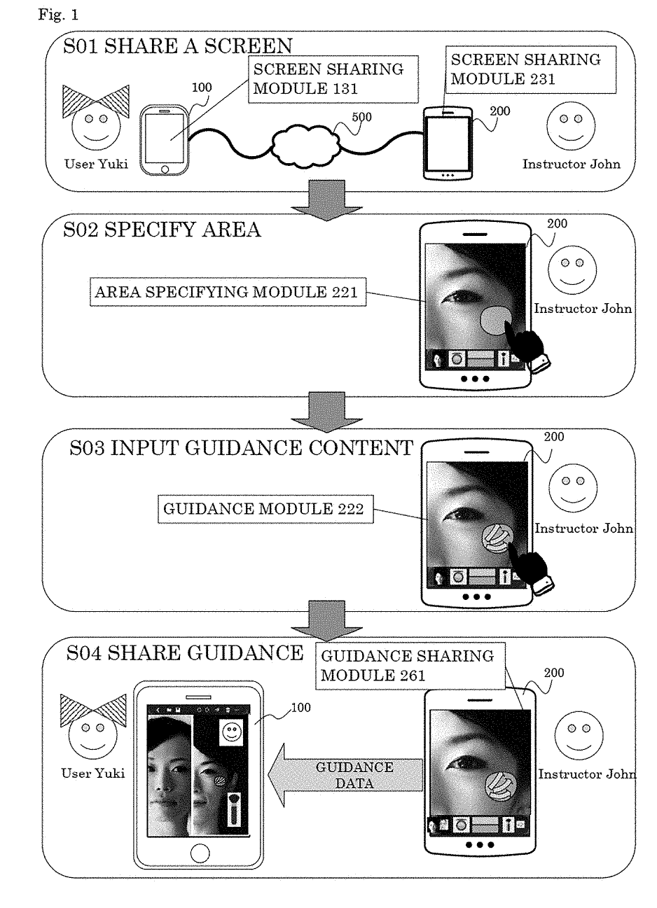

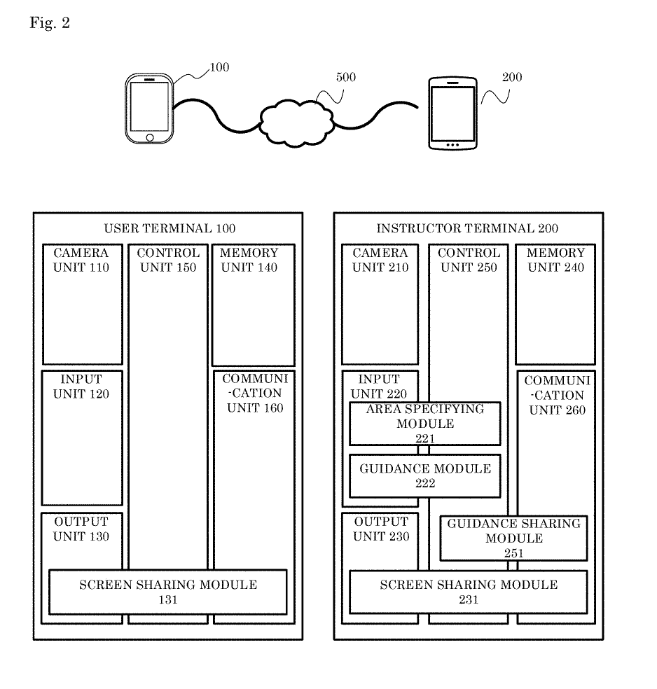

The overview of the present invention will be described below with reference to FIG. 1. The system for sharing a screen at least includes an instructor terminal 200 and a user terminal 100, which may be achieved by including a computer such as a server intermediating between the both terminals. The user terminal 100 includes a camera unit 110, an input unit 120, an output unit 130, a memory unit 140, a control unit 150, and a communication unit 160 as shown in FIG. 2. The output unit 130 achieves a screen sharing module 131 in cooperation with the control unit 150 and the communication unit 160. The instructor terminal 200 includes a camera unit 210, an input unit 220, an output unit 230, a memory unit 240, a control unit 250, and a communication unit 260 as shown in FIG. 2. The input unit 220 achieves an area specifying module 221 and a guidance module 222 in cooperation with the control unit 250. The output unit 230 achieves a screen sharing module 231 in cooperation with the control unit 250 and the communication unit 260. The communication unit 260 achieves a guidance sharing module 251 in cooperation with the control unit 250. The user terminal 100 and the instructor terminal 200 are connected through a communication network 500. The communication network 500 may be a public or private line network. The user terminal 100 may be directly connected with the instructor terminal 200 through peer to peer communication.

When the guidance is offered through screen sharing, the screen sharing module 131 of the user terminal 100 and the screen sharing module 231 of the instructor terminal 200 first perform screen sharing (step S01). The screen sharing means that information such as images and voices output on and from a screen in real time is shared between the user terminal 100 and the instructor terminal 200. The screen sharing enables the output unit 130 of the user terminal 100 to view what the output unit 230 of the instructor terminal 200 outputs, and vice versa, so that the terminals can recognize the screen of each other. As a result, the system produces an effect as if the user meets to directly receive guidance. The screens of both the terminals can display the images taken by the camera unit 110 or 210, the data input from the input unit 120 or 220, etc. The screen sharing method is not limited to the scope of the present invention. Any existing technologies are applicable.

Then, the area specifying module 221 of the instructor terminal 200 specifies an area in response to an instruction from the instructor (step S02). For example, when the guidance is offered for makeup, the area to be put on makeup is specified in the facial image data of the user with which the screen is shared. In FIG. 1, the area is specified to put on blusher. The number of areas to be specified may be not only one but also two or more.

Then, the guidance module 222 receives an input of guidance content in response to the input from the instructor (step S03).

FIG. 1 shows the color of blush, the type of brush to be used, the position, the direction, the number of times, and the order of the brush to be moved in the area specified in the step S02. If there are two or more areas, a different guidance content may be input for each area.

Finally, the guidance sharing module 251 shares the input guidance content (step S04). The instructor terminal 200 transmits the input guidance content to the user terminal 100 as guidance data, and then the user terminal 100 outputs the guidance data.

FIG. 1 shows that the right half side of the user terminal 100 displays the makeup guidance data received from the instructor and also that the left half side displays the user's image that the user took by using the camera unit 110 to put on makeup as checking the makeup. The screen sharing also enables the instructor terminal 200 to check and guide the user's makeup in real time.

The steps S02 to S04 may be performed repeatedly until the guidance and then the screen sharing are ended. Moreover, guidance may be offered more than once by inputting a guidance content in the step S03 without changing the area specified in the step S02 as appropriate.

### Functions

FIG. 2 shows a functional block diagram of the user terminal 100 and the instructor terminal 200 to show the relationship among the functions. The user terminal 100 includes a camera unit 110, an input unit 120, an output unit 130, a memory unit 140, a control unit 150, and a communication unit 160. The output unit 130 achieves the screen sharing module 131 in cooperation with the control unit 150 and the communication unit 160. The instructor terminal 200 includes a camera unit 210, an input unit 220, an output unit 230, a memory unit 240, a control unit 250, and a communication unit 260. The input unit 220 achieves the area specifying module 221 and the guidance module 222 in cooperation with the control unit 250. The output unit 230 achieves the screen sharing module 231 in cooperation with the control unit 250 and the communication unit 260. The communication unit 260 achieves the guidance sharing module 251 in cooperation with the control unit 250. The user terminal 100 and the instructor terminal 200 are connected through a communication network 500. The communication network 500 may be a public or private line network. The user terminal 100 may be directly connected with the instructor terminal 200 through peer to peer communication.

The user terminal 100 may be a general information terminal with which a user can take an image by using the camera, which is an information device or an electrical appliance with functions to be described later. For example, the user terminal 100 may be a general information appliance such as a mobile phone, a smart phone, a tablet PC, a notebook, a wearable device, or an electronic appliance, which has a camera function or connectivity with an external camera such as a web camera, or a PC with a display. The smart phone shown as the user terminal 100 in the attached drawings is just one example.

The user terminal 100 includes a camera in the camera unit 110. The camera unit 110 takes and converts an image into digital data and stores the digital data in the memory unit 140. The image may be a still image or a moving image. If the image is a moving image, the control unit 150 can capture a part of the moving image to store in the memory unit 140 as a still image. The obtained taken image is an accurate image with information as much as the user needs. The pixel count and the image quality can be specified.

The input unit 120 has functions necessary for screen sharing and operation of the camera. The input unit 120 may include a liquid crystal display to achieve a touch panel function, a key board, a mouse, a pen tablet, and a hardware button on the device, and a microphone to perform voice recognition. The input unit 120 preferably also has a microphone function, etc., to take place voice interaction with the instructor terminal 200. The features of the present invention are not limited in particular by an input method.

The output unit 130 achieves the screen sharing module 131 in cooperation with the control unit 150 and the communication unit 160. The output unit 130 has functions necessary to display screen-shared images and output voices. Examples of the device to display the images may include a liquid crystal display, a PC display, and a projector. Examples of the device to output voices may include a speaker, an earphone, and a headphone. The features of the present invention are not limited in particular by an output method.

The memory unit 140 includes a data storage unit such as a hard disk or a semiconductor memory to store the taken moving and still images and data received from the instructor terminal 200.

The control unit 150 includes a central processing unit (hereinafter referred to as “CPU”), a random access memory (hereinafter referred to as “RAM”), and a read only memory (hereinafter referred to as “ROM”).

The communication unit 160 includes a Wireless Fidelity (Wi-Fi®) enabled device complying with, for example, IEEE 802.11, or a wireless device complying with the IMT-2000 standard such as the third generation mobile communication system. The communication unit 160 may include a wired device for LAN connection. The user terminal 100 can transmit images and voices of the display on the output unit 130 through the communication unit 160.

The instructor terminal 200 may be a general information terminal with which an instructor can take an image by using the camera, which is an information device or an electrical appliance with functions to be described later. For example, the instructor terminal 200 may be a general information appliance such as a mobile phone, a smart phone, a tablet PC, a notebook, a wearable device, or an electronic appliance, which has a camera function or connectivity with an external camera such as a web camera, or a PC with a display. The smart phone shown as the instructor terminal 200 in the attached drawings is just one example.

The instructor terminal 200 includes a camera in the camera unit 210. The camera unit 210 takes and converts an image into digital data and stores the digital data in the memory unit 240. The image may be a still image or a moving image. If the image is a moving image, the control unit 250 can capture a part of the moving image to store in the memory unit 240 as a still image. The obtained taken image is an accurate image with information as much as the instructor and the user need. The pixel count and the image quality can be specified.

The input unit 220 has functions necessary for screen sharing and operation of the camera. The input unit 220 may include a liquid crystal display to achieve a touch panel function, a key board, a mouse, a pen tablet, and a hardware button on the device, and a microphone to perform voice recognition. The input unit 220 preferably also has a microphone function, etc., to take place voice interaction with the user terminal 100. The features of the present invention are not limited in particular by an input method. The input unit 220 achieves the area specifying module 221 and the guidance module 222 in cooperation with the control unit 250.

The output unit 230 achieves the screen sharing module 231 in cooperation with the control unit 250 and the communication unit 260. The output unit 230 has functions necessary to display screen-shared images and output voices. Examples of the device to display the images may include a liquid crystal display, a PC display, and a projector. Examples of the device to output voices may include a speaker, an earphone, and a headphone. The features of the present invention are not limited in particular by an output method.

The memory unit 240 includes a data storage unit such as a hard disk or a semiconductor memory to store the taken moving and still images and data received from the user terminal 100.

The control unit 250 includes a CPU, a RAM, and a ROM. The control unit 250 achieves the guidance sharing module 251 in cooperation with the communication unit 260.

The communication unit 260 includes a Wi-Fi® enabled device complying with, for example, IEEE 802.11, or a wireless device complying with the IMT-2000 standard such as the third generation mobile communication system. The communication unit may include a wired device for LAN connection. The instructor terminal 200 can transmit images and voices of the display on the output unit 230 through the communication unit 260.

The user terminal 100 and the instructor terminal 200 are connected through a communication network 500. The communication network 500 may be a public or private line network. The user terminal 100 may be directly connected with the instructor terminal 200 through peer to peer communication.

### Guidance Process Through Screen Sharing

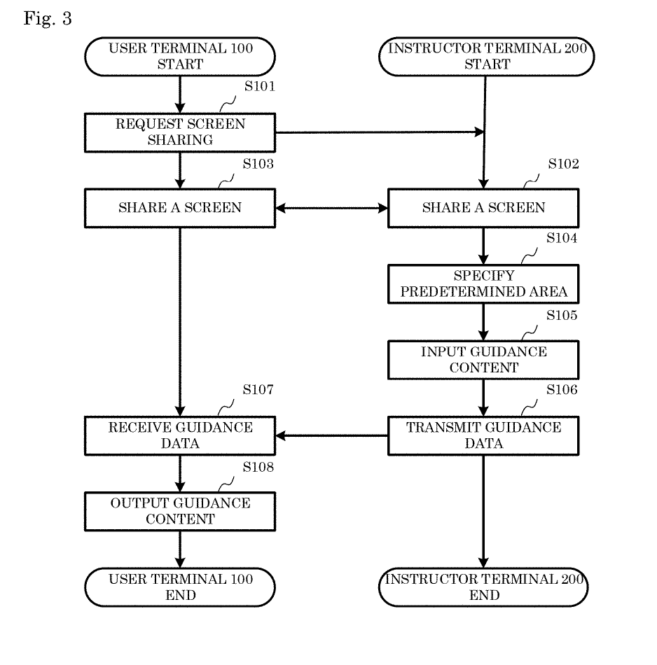

FIG. 3 shows a flow chart of the guidance process performed by the user terminal 100 and the instructor terminal 200 through screen sharing.

First, the user terminal 100 transmits a screen sharing request to the instructor terminal 200 by using the communication unit 160 (step S101). If a plurality of instructor terminals 200 exist, the user terminal 100 can transmit a screen sharing request to a desired instructor terminal 200.

The instructor terminal 200 receives the screen sharing request from the user terminal 100 and then performs screen sharing by using the screen sharing module 231 if the instructor terminal 200 can accept the screen sharing request (step S102). If the instructor terminal 200 has accepted the screen sharing request, the user terminal 100 also performs screen sharing by using the screen sharing module 131 (step S103).

The screen sharing means that information such as images and voices output on and from a screen in real time is shared between the user terminal 100 and the instructor terminal 200. The screen sharing enables the output unit 130 of the user terminal 100 to view what the output unit 230 of the instructor terminal 200 outputs, and vice versa, so that the terminals can recognize the screen of each other. As a result, the system produces an effect as if the user meets to directly receive guidance. The screens of both the terminals can display the images taken by the camera unit 110 or 210, the data input from the input unit 120 or 220, etc. The screen sharing method is not limited to the scope of the present invention. Any existing technologies are applicable.

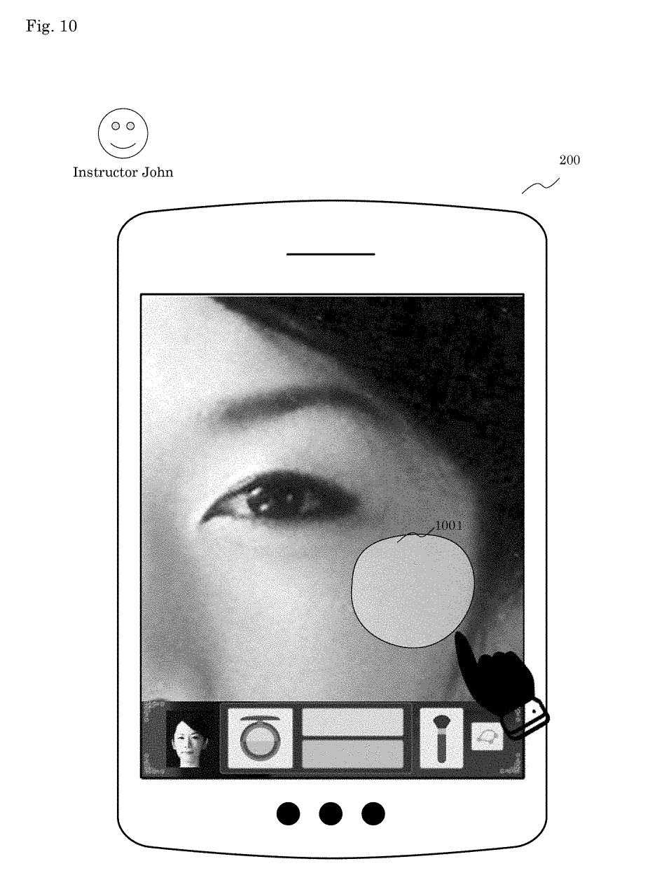

Then, the area specifying module 221 of the instructor terminal 200 specifies a predetermined area in response to an instruction from the instructor (step S104). For example, when the guidance is offered for makeup, the area to be put on makeup is specified in the facial image data of the user with which the screen is shared. FIG. 10 shows one example of the screen of the instructor terminal 200 when the instructor specifies an area. In FIG. 10, the area 1001 is specified to put on blusher. The number of areas to be specified may be not only one but also two or more. For example, for a cheek shown in FIG. 10, the right cheek area may be specified at the same time as the left cheek area 1001.

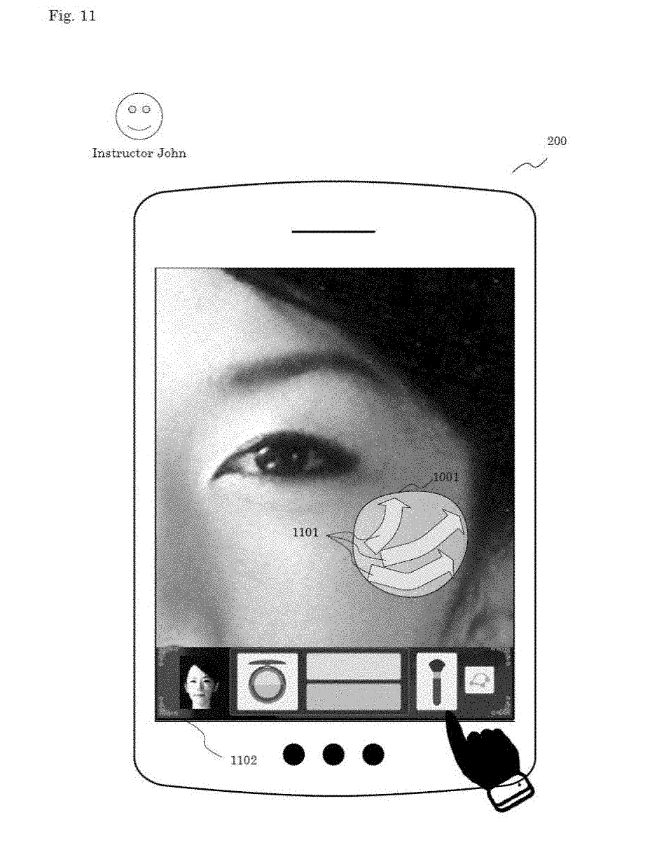

After a predetermined area is specified, the guidance module 222 receives an input of guidance content for the specified area in response to the input from the instructor (step S105). FIG. 11 shows one example of the screen of the instructor terminal 200 when the instructor guides makeup to be put on the specified area. FIG. 11 shows the position and the direction where blush should be put on in the area 1001 specified in the step S104 by an arrow 1101. The area 1102 may display the overall view of the makeup method, the type and the color of cosmetics to be used, the type of brush to be used, the shape of the specified area, etc. Moreover, the content selected in the area 1102 may be output by texts and voices as the guidance content. The position, the direction, the number of times, the order, etc., of the brush to be moved in the area 1001 are not shown in FIG. 11 but may be input and displayed. If there are two or more specified areas, a different guidance content may be input for each area.

To share the guidance content, the guidance sharing module 251 then transmits the input guidance data to the user terminal 100 through the communication unit 260 (step S106). The guidance data includes a content input from the instructor terminal 200, which is necessary to output the guidance content to the user terminal 100. The input content includes the position and the shape of the above-mentioned predetermined area, the type and the color of cosmetics to be used, the type of brush to be used, the position, the direction, the number of times, and the order of makeup.

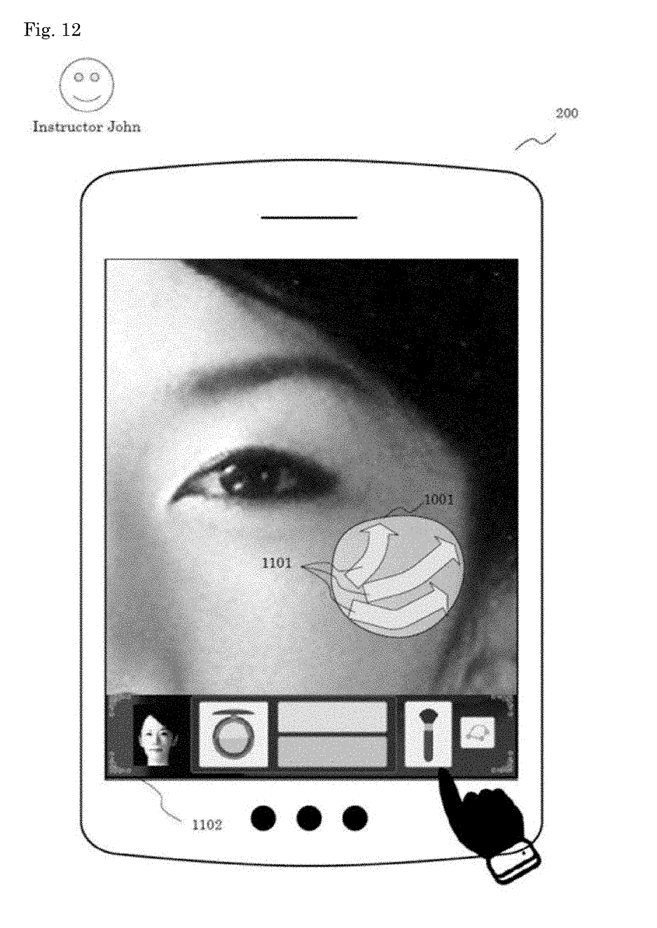

The user terminal 100 receives the guidance data from the instructor terminal 200 by using the communication unit 160 (step S107) and outputs the guidance content to the output unit 130 (step S108). FIG. 12 shows one example of the screen of the user terminal 100 when the instructor terminal 200 transmits guidance data to the user terminal 100 and shares the guidance content. FIG. 12 shows that the right half area 1203 of the user terminal 100 displays the makeup guidance data received from the instructor and also that the left half area 1204 displays the user's image that the user took by using the camera unit 110 to put on makeup as checking the makeup. The area 1202 displays the instructor's image taken by the camera unit 210 of the instructor terminal 200. The screen sharing also enables the instructor terminal 200 to check and guide the user's makeup in real time. In this case, the user more easily understands the guidance because the area 1202 displays what the instructor is doing. As shown in FIG. 12, the area 1201 may display icons to store the guidance from the instructor terminal 200 and to check the guidance content in detail.

The steps S104 to S108 may be performed repeatedly until the guidance and then the screen sharing are ended. Moreover, guidance may be offered more than once by inputting a guidance content in the step S105 without changing the area specified in the step S104 in response to a user's request for more than one types of eye makeup, for example. The screen sharing can be ended from the user terminal 100 and the instructor terminal 200.

### Guidance Content Storing Process and Evaluation Process

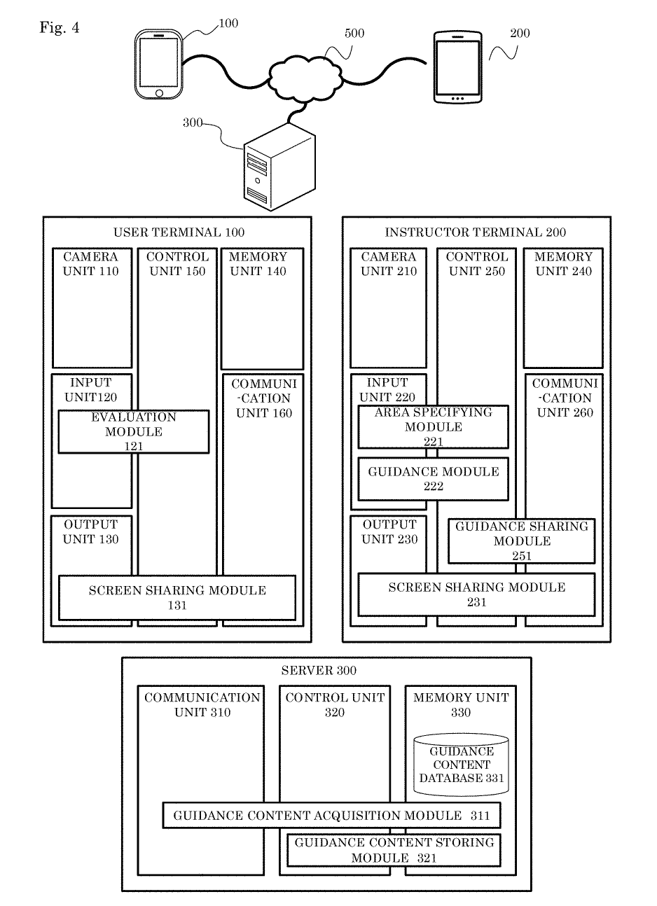

FIG. 4 shows a functional block diagram of the user terminal 100, the instructor terminal 200, and the server 300 to illustrate the relationship among the functions. The server 300 is connected through a communication network 500 in addition to the configuration including the user terminal 100 and the instructor terminal 200 as shown in FIG. 2. The communication network 500 may be a public or private line network. In the user terminal 100, the output unit 130 achieves an evaluation module 121 in cooperation with the control unit 150 in addition to the configuration of FIG. 2. The server 300 includes a communication unit 310, a control unit 320, and a memory unit 330. The memory unit 330 includes a guidance content database 331. The communication unit 310 achieves a guidance content acquisition module 311 in cooperation with the control unit 320 and the memory unit 330. The memory unit 330 achieves a guidance content storing module 321 in cooperation with the control unit 320.

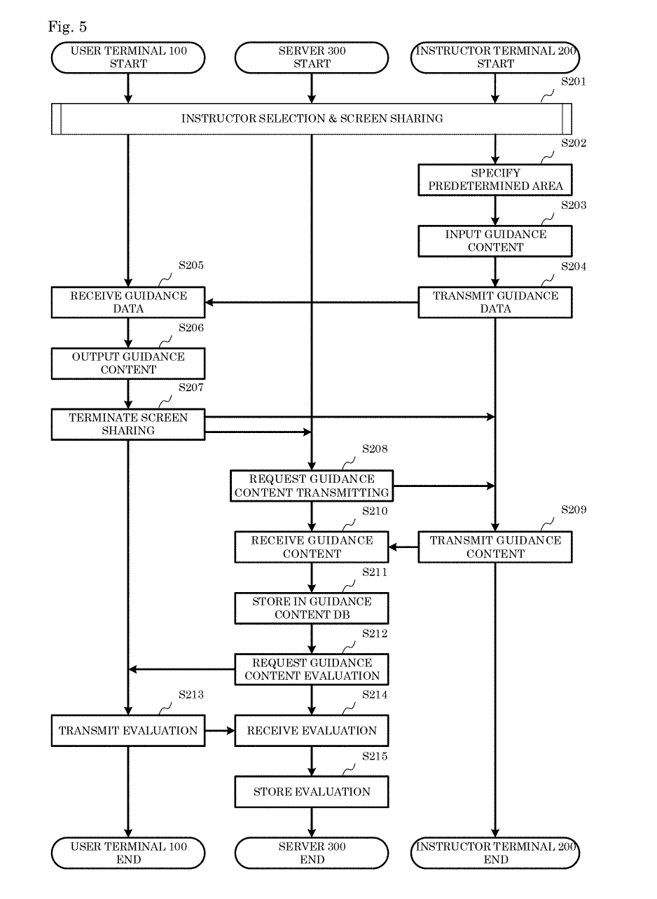

FIG. 5 shows a flow chart of the guidance content storing process and the evaluation process performed by the user terminal 100, the instructor terminal 200, and the server 300 after the guidance process.

First, the instructor selection process and the screen sharing process are performed (step S201). Details of these processes will be described later.

The step in which the instructor terminal 200 presents makeup samples to the user terminal 100 to allow the user to select a favorite one from the presented makeup samples is not shown in FIG. 5 but may be added after the step S201.

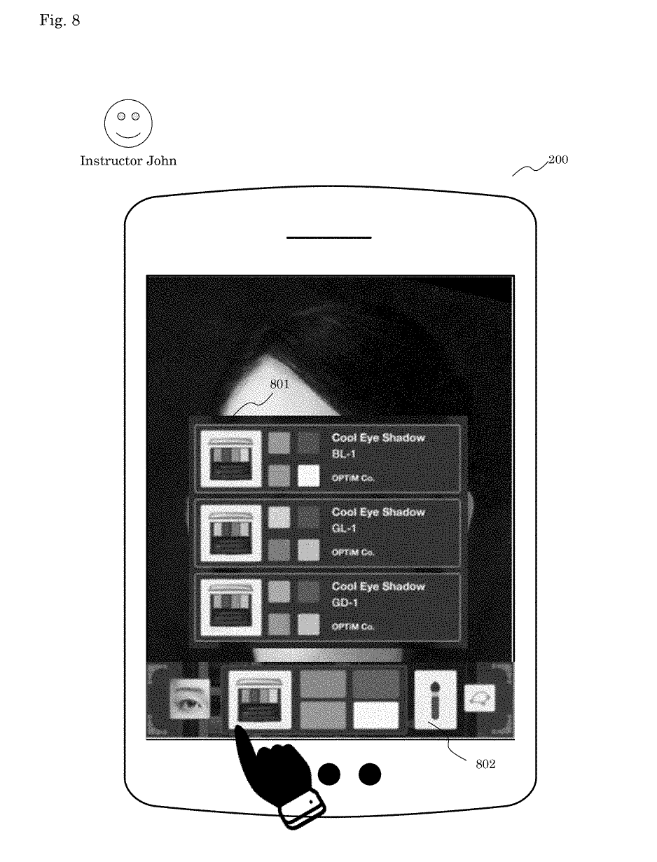

FIG. 8 shows one example of the screen of the instructor terminal 200 when the instructor generates a makeup sample. A makeup method that may be suitable for the user's facial image acquired through screen sharing is input through the input unit 220 of the instructor terminal 200. The area 801 displays an example to select a color from a makeup color palette. The area 802 may allow the instructor to select a type and a color of cosmetics to be used, a type of brush to be used, a shape of the specified area, etc.

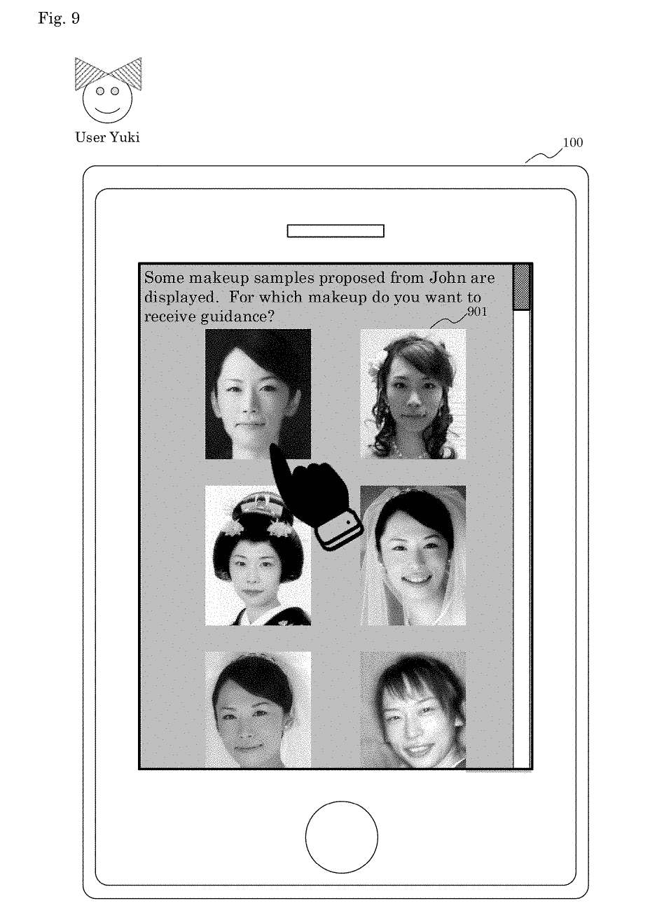

FIG. 9 shows one example of the screen of the user terminal 100 when the user selects a makeup sample. A plurality of makeup samples received from the instructor terminal 200 are output to the output unit 130 as thumbnail images 901. Then, the user can select a makeup sample to share how the following guidance is provided between the user terminal 100 and the instructor terminal 200.

Then, the area specifying module 221 of the instructor terminal 200 receives a specified predetermined area (step S202). This process may be the same as the step S104 in FIG. 3.

After a predetermined area is specified, the guidance module 222 receives an input of guidance content for the specified area in response to the input from the instructor (step S203). This process may be the same as the step S105 in FIG. 3.

To share the guidance content, the guidance sharing module 251 then transmits the input guidance data to the user terminal 100 through the communication unit 260 (step S204). This process may be the same as the step S106 in FIG. 3.

The user terminal 100 receives the guidance data from the instructor terminal 200 by using the communication unit 160 (step S205) and outputs the guidance content to the output unit 130 (step S206). This process may be the same as the steps S107 and S108 in FIG. 3.

The steps S202 to S206 may be performed repeatedly until the guidance and then the screen sharing are ended. Moreover, guidance may be offered more than once by inputting a guidance content in the step S203 without changing the area specified in the step S202 in response to a user's request for more than one types of eye makeup, for example.

When the guidance is ended, the communication unit 160 of the user terminal 100 notifies the instructor terminal 200 and the server 300 that the screen sharing with the instructor terminal 200 is to be ended (step S207). FIG. 5 shows an example when the user terminal 100 notifies that the screen sharing is to be ended. However, the instructor terminal 200 notifies the user terminal 100 and the server 300 that the screen sharing with the user terminal 100 is to be ended.

In response to the notification that the screen sharing is to be ended, the guidance content acquisition module 311 of the server 300 transmits a guidance content transmitting request to the instructor terminal 200 (step S208).

The instructor terminal 200 transmits guidance data in response to the guidance content transmitting request (step S209). The guidance data is information to reproduce the guidance content, including moving image data while the screen of the instructor terminal 200 is being shared, area specifying data to specify a predetermined area, and instruction data to offer guidance for a predetermined area. The moving image data may be in a generally used data format such as Audio Video Interleave, Advanced Systems Format, MPEG, MPEG4, 3GPP, or Flash Video depending on the system. The area specifying data and the instruction data may be stored as either or both vector data and text data. The features of the present invention are not limited in particular by the data formats of the moving image data, the area specifying data, and the instruction data. The guidance data is stored in the memory unit 240 when the screen of the instructor terminal 200 is shared. In this case, the data may be encrypted as appropriate.

The server 300 receives the guidance data by using the guidance content acquisition module 311 (step S210).

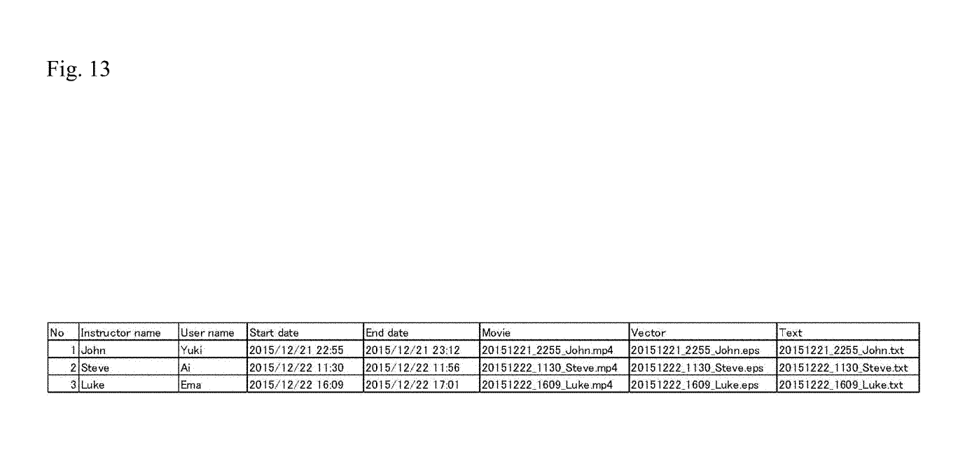

The guidance content storing module 321 stores this received data in the guidance content database 331 (step S211). FIG. 13 shows one example of guidance data stored in the guidance content database. In this example, instructor names, user names, start and end dates of guidance, and file names of stored moving image data, vector data, and text data are stored. Since guidance contents are stored in the guidance content database, the guidance contents are reproducible to use to check the guidance that the user terminal 100 received before.

Then, the server 300 transmits a guidance content evaluation request to the user terminal 100 (step S212). The server 300 may transmit items desired to be evaluated from the user terminal 100 together with this guidance content evaluation request.

The user terminal 100 inputs an evaluation of the guidance content and transmits the evaluation to the server 300 by using the evaluation module 121 (step S213).

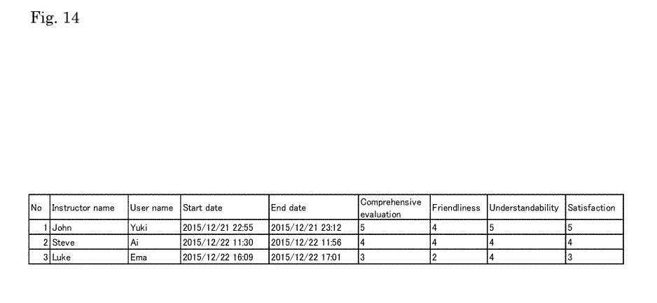

The server 300 receives the evaluation (step S214) and stores the evaluation in the memory unit 330 (step S215). FIG. 14 shows one example of data on the evaluation of the guidance content. In this example, the evaluation data includes an instructor name, a user name, the start date and date of the guidance, and a numerical value representing the evaluation transmitted from the user terminal 100. The evaluation items and the evaluation value ranges may be arbitrarily defined depending on the system. Examples of the evaluation item in FIG. 14 include comprehensive evaluation, friendliness, understandability, and satisfaction. The evaluation data may be stored in the guidance content database together with the guidance data or in an evaluation database associated with the guidance content database.

The guidance content storing process of the steps S208 to S211 may be performed after the evaluation process from the steps S212 to S215. Alternatively, only any one of the guidance content storing process and the evaluation process may be performed.

### Instructor Selection Process and Screen Sharing Process

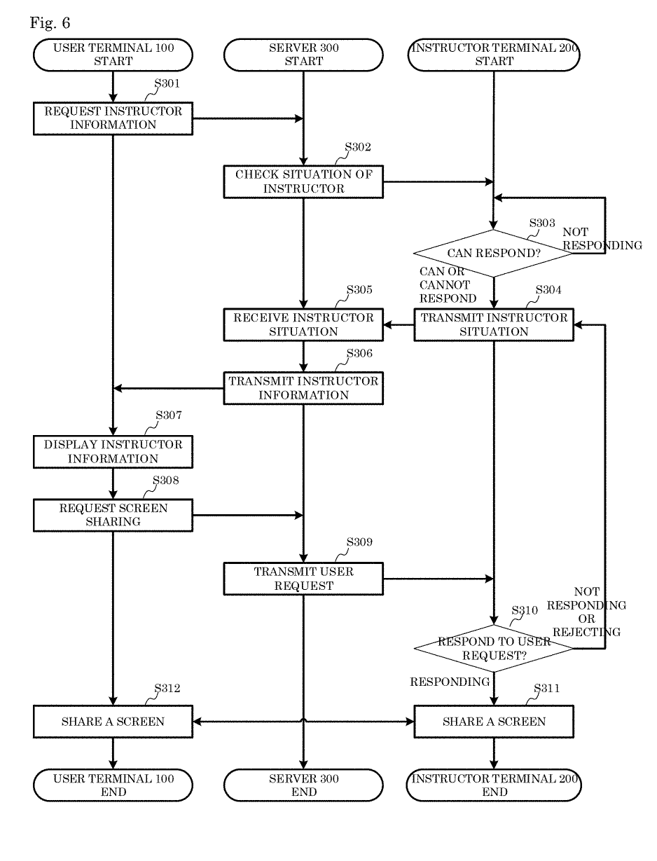

FIG. 6 shows a flow chart of the instructor selection process and the screen sharing process performed by the user terminal 100, the instructor terminal 200, and the server 300. These processes are performed in the step S201 in FIG. 5. When a plurality of instructor terminals 200 exist, the user terminal 100 has to select an instructor from whom the user wishes to receive guidance.

First, the user terminal 100 requests instructor information from the server 300 (step S301). This is to acquire instructor information if two or more instructors exist.

The server 300 accesses the database to check the situation of the instructor in response to this request (step S302). To manage information on instructors in the server 300, an instructor database may be provided in the memory unit 330. The status of all the instructors may be checked. Alternatively, a weekday and a time at which an instructor can respond may be previously registered in the instructor information database. The status of only an instructor who can respond at that time may be checked.

The instructor terminal 200 that has received the check from the server 300 judges whether or not the instructor can respond (step S303). This judgment may be performed based on some response that the instructor inputs to a question from the instructor terminal 200 or based on the instructor's logged-in status in which online, away from computer, busy, offline, etc., is previously set in the same way as application software offering a chat service, etc.

As a result of the judgement, if the instructor can or cannot surely make a response, the instructor terminal 200 transmits the instructor's status to the server 300 (step S304). However, if the instructor's status is uncertain because for example, the instructor does not input any response to the question from the instructor terminal 200, the status may be checked at a regular interval until a response is received.

The server 300 receives the instructor's status from the instructor terminal 200 (step 305).

The server 300 generates instructor information based on the instructor data and the received data and transmits the instructor information to the user terminal 100 (step S306). The instructor information includes the name, profile, photograph, and online or offline status of the instructor, makeup reference images that the instructor worked on, which are necessary for the user to select an instructor from the user terminal 100. Moreover, the number of times that the user of the user terminal 100 received guidance from each instructor in the past may be added.

The user terminal 100 displays instructor information on the output unit 130 based on the received instructor information (step S307).

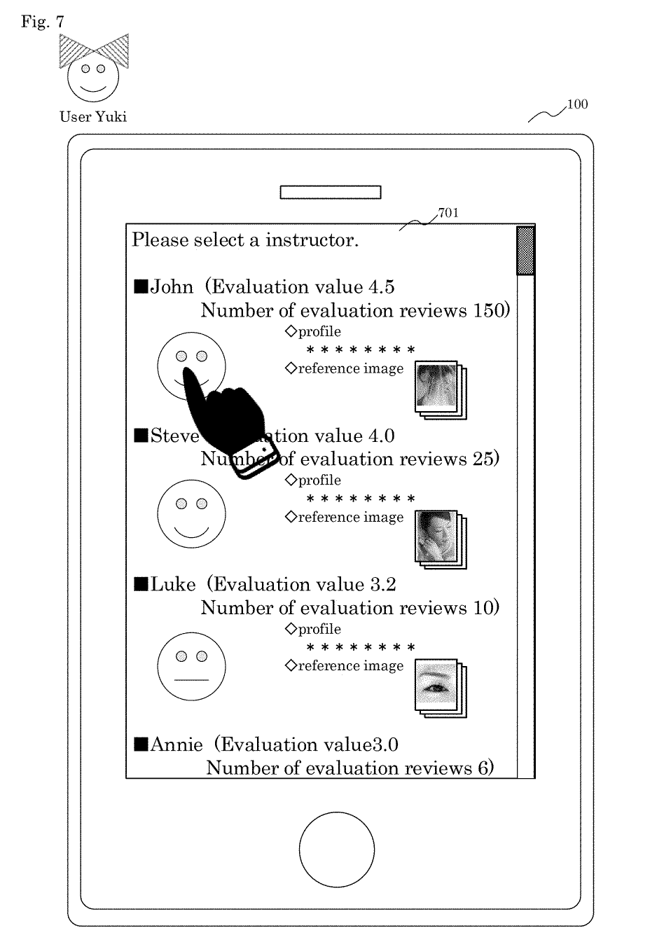

FIG. 7 shows one example of the screen of the user terminal 100 when the user selects an instructor. In this example, the name, the profile, the face photo, and the average evaluation value, the number of evaluation reviews, or makeup reference images that the instructor worked on are displayed. The online or offline status of the instructor is not shown in FIG. 7 but may be displayed. The order of displaying instructors can be appropriately set by the system and the user by putting a priority on the instructor in the online status, the evaluation ranking, the number of times that the user received guidance in the past, etc. In FIG. 7, the message 701 questions which instructor the user asks for guidance.

The user selects an instructor based on the displayed instructor information and transmits a screen sharing request with the instructor terminal 200 of the selected instructor to the server 300 (step S308).

The server 300 receives this screen sharing request and transmits a user request to the desired instructor terminal 200 (step S309). In addition to the screen sharing request from the user, the server may transmit information on the name, the gender, the age, the favorite makeup reference images, etc. of the user to the instructor terminal 200.

The instructor terminal 200 checks whether or not to respond to the request from the user (step S310).

The instructor terminal 200 performs screen sharing by using the screen sharing module 231 if the instructor terminal 200 can accept the screen sharing request from the user (step S311).

If the instructor terminal 200 has accepted the screen sharing request, the user terminal 100 also performs screen sharing by using the screen sharing module 131 (step S312).

If not responding to the user request within a certain time or if rejecting the user request, the instructor terminal 200 returns to the instructor situation transmitting process of the step S304 and notifies the user terminal 100 through the server 300 that the selected instructor cannot respond to the screen sharing request. The server 300 updates and transmits instructor information to the user terminal 100 to allow the user to select an instructor again.

The images taken by the camera units 110 and 210 are output on the user terminal 100 and the instructor terminal 200 together with voices during screen sharing. This enables the user terminal 100 to do something such as makeup according to the guidance from the instructor terminal 200. The screen sharing method is not limited to the scope of the present invention. Any existing technologies are applicable.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), DVD (e.g., DVD-ROM, DVD-RAM), or compact memory. In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

100 User terminal
200 Instructor terminal
300 Server
500 Communication network

What is claimed is:

1. A system for screen sharing comprising an instructor terminal and a user terminal, wherein the instructor terminal includes:
an area specifying unit that specifies a predetermined area in a shared area in which a screen is shared;
a guidance unit that provides guidance to the predetermined area; and
a guidance sharing unit that transmits the guidance to the user terminal to share the guidance.

2. The system according to claim 1, wherein the guidance is on how to put on makeup.

3. A system for screen sharing comprising one or more instructor terminals, one or more user terminals, and a server, the server being provided with a guidance content database and communicatively connected with the instructor terminals and the user terminals, wherein the server includes:
a guidance content acquisition unit that acquires the content of guidance that the instructor terminal provides to the user terminal; and
a guidance content storing unit that stores the acquired content in the guidance content database.

4. The system according to claim 3, wherein the user terminal includes an evaluation unit that evaluates the content of the guidance.

5. A system for screen sharing comprising one or more instructor terminals, one or more user terminals, and a server, the server being provided with a guidance content database and communicatively connected with the instructor terminals and the user terminals, wherein the user terminal includes:
a screen sharing unit that selects a desired instructor terminal and shares a screen with the selected desired instructor terminal; and
an evaluation unit that evaluates the content of the guidance,
the instructor terminal includes:
an area specifying unit that specifies a predetermined area in a shared area in which a screen is shared;
a guidance unit that provides guidance on makeup to the predetermined area;
a guidance sharing unit that transmits the guidance on makeup to the user terminal to share the guidance, and
the server includes:
a guidance content acquisition unit that acquires the content of guidance that the instructor terminal provides to the user terminal;
a guidance content storing unit that stores the acquired content in the guidance content database; and
an evaluation unit that evaluates the content of the guidance.

6. The system according to claim 5, wherein the evaluation for the content of the guidance is referable when the user terminal selects a desired instructor terminal.

7. A method for screen sharing between an instructor terminal and a user terminal including the steps of:
specifying a predetermined area in a shared area in which a screen is shared by the instructor terminal;
providing guidance to the predetermined area by the instructor terminal; and
transmitting the guidance from the instructor terminal to the user terminal to share the guidance between the instructor terminal and the user terminal.
